(19) United States
(12) Patent Application Publication
(10) Pub. No.: US 2024/0301147 A1
(43) Pub. Date: Sep. 12, 2024

(54) HIGHLY LOADED TRANS-POLYOCTENAMER-GRAPHENE COMPOSITE MATERIAL, METHOD FOR ITS PRODUCTION AND USE THEREOF

(71) Applicant: EVONIK OPERATIONS GMBH, Essen (DE)

(72) Inventors: Valeri LEICH, Duisburg (DE); Alexander Paasche, Haltern am See (DE); Stefan Schumann, Remscheid (DE); Dorothea Spannenkrebs, Marl (DE); Alexey Merkulov, Marl (DE); Verena Breuers, Haltern am See (DE); Christian Däschlein, Herne (DE); Uwe Paulmann, Luedinghausen (DE); Jonas Hönig, Ingelheim am Rhein (DE)

(73) Assignee: EVONIK OPERATIONS GMBH, Essen (DE)

(21) Appl. No.: 18/260,570

(22) PCT Filed: Dec. 23, 2021
(86) PCT No.: PCT/EP2021/087462

§ 371 Date: Jul. 6, 2023

(30) Foreign Application Priority Data
Jan. 8, 2021 (EP) 21150690.2

(51) Int. Cl. C08J 3/215; C08G 61/08; C08K 3/04

(52) U.S. Cl. CPC C08J 3/215; C08G 61/08; C08K 3/042; C08G 2261/418; C08J 2365/00

(57) ABSTRACT

A process can be used for production of trans-polyoctenamer-graphene composite material having a high filler content, from a trans-polyoctenamer and graphene material. The highly filled trans-polyoctenamer-graphene composite material is useful, for example, in the automotive sector, in heat exchangers, in housings, encapsulations, plain bearings, in 3-D printing heads for heat removal, injection moulded parts, electronics applications, hose systems, membranes, fuel cells, cable systems, indoor and sports apparel, EM protection, and orthopaedics.

The present invention relates to a process for production of trans-polyoctenamer-graphene composite material having a high filler content, to the highly filled trans-polyoctenamer-graphene composite material itself and to the use thereof.

Graphene and production, properties and applications thereof are discussed in detail in the technical literature, for example in Römpp online, https://roempp.thieme.de/lexicon/RD-07-02758.

Just as in graphite, each carbon atom in graphene is linked covalently to three neighbouring atoms by way of a sigma bond. The C, C bond length is 142 pm. The atoms are sp² hybridized, and the sigma bonds lie within a plane. Graphene accordingly has a planar structure. A partially filled p_{z} orbital remains on each atom. These p_{z} orbitals are orthogonal to the plane of the bonds and form a delocalized Pi-electronic system which is of primary importance in determining the electronic properties of graphene.

In crystallographic terms, graphene can be described via two equivalent sublattices with elementary-cell vectors \vec{a}=\vec{b}=0.246 nm, the angle between these being 60°. The elementary cell consists of two carbon atoms at the respective positions (0, 0) and (a/3, 2b/3). Atomic density is therefore 38.2 nm⁻².

For the purposes of the invention, the expression “graphene material” means material(s) in accordance with ISO/TS 80004-13, namely
graphene,
graphenic carbon materials,
mono-, bi- and trilayer graphene,
epitaxial graphene,
exfoliated graphene,
few-layer graphene,
multilayer graphene,
few-layered nanoribbons,
graphene nanoplate,
graphene nanoplatelet,
graphene nanosheet.
graphene microsheet,
graphene nanoflakes.
graphene nanoribbon,
graphene oxide,
graphene oxide nanosheet,
multilayer graphene oxide,
graphene quantum dot,
graphite,
graphite nanoplate,
graphite nanosheet,
graphite nanoflake,
graphite oxide,
reduced graphene oxide,
   and also carbon blacks, carbon nanotubes or a mixture of these materials.

Graphene materials are used in a large number of technical fields.

WO 2015/055252 A1 discloses vinylsilanes which may be used in rubber mixtures comprising graphene materials in the production of tyres for example.

CN 104342003 A presents aqueous coating materials which are dust- and bacteria-repellent, for glass doors. Graphene, inter alia, is used in the production of the said coating materials.

CN 105056879 A teaches how mechanical properties of asphalt can be improved by a composition comprising polyester fibres and graphene.

Production of vulcanized rubber mixtures can use concentrates comprising graphene and sulfonamides alongside other materials. CN 107459717 A discloses such concentrates and their production processes.

Graphene material is also used for protection from rotting in construction materials. According to the teaching of CN 108947394 A, modified graphene oxide is incorporated into Portland cement, alongside other materials.

WO 2019/145307 A1 discloses compositions comprising polymeric, inorganic nanoparticles and use of said compositions in lubricants on metallic surfaces. Nanoparticles used are inter alia graphene.

Graphene materials are obtainable commercially as powders and often have very low bulk densities, for example in the range between 2 and 400 g/l. Alongside the low bulk densities, most graphene materials also have poor flowability and/or generate high dust content during transfer by gravity-driven flow. This leads to poor handling properties and to problems during weighing-out and metering, and must also be considered critically in relation to aspects involving protection of the environment and safety of operators.

The poor handling properties are apparent by way of example when the powders are incorporated in elastomeric systems, as is the case during the kneading of rubber: Production of a good filled rubber compound is contingent on incorporation of pulverulent fillers at the correct juncture and over the correct duration. These are poured into the mixing chamber by means of a hopper and then pushed in the direction of rotating rollers by a pneumatic piston. The shear forces in play during such a mixing process break up agglomerates of the filler and thus contribute to its distribution. The maximum achievable filler content is therefore decisively determined by the shear forces in play.

However, it is difficult to achieve/control high filler contents in particularly soft polymer mixtures having a low viscosity since the lower the viscosity of the polymer or the polymer mixture, the lower the shear forces that may be established for realizing desired filler contents. An extreme case is the class of rubbers known as polyoctenamers. These have such a low viscosity in the mixing process that use as a base polymer for filled mixtures is not possible.

By way of example the maximum filler content achievable with conventional compounding methods, typically using rollers, internal mixers or extruders, is 75%. This hitherto highest achieved filer content to the knowledge of the inventors is realized for example with sulfur as the filer. In the present prior art filled polyoctenamers are thus employed exclusively as blend component of compounds.

The present invention accordingly has for its object to provide a process which makes it possible to produce from polyoctenamers and a filler a material having adjustable, preferably high, filler contents of this filler.

The inventors have surprisingly found a process that achieves this object with graphene material as filer.

The Invention provides a process for producing trans-polyoctenamer-graphene composite material by performing steps a-d:
a) dissolving trans-polyoctenamer in at least one organic solvent to obtain a polymer solution of the trans-polyoctenamer and subsequently
b) introducing graphene material into this polymer solution while introducing power to obtain a trans-polyoctenamer-graphene reaction solution and subsequently
c) precipitating this reaction solution in at least one further solvent or removing the solvent(s) employed in step a by drying the reaction solution to obtain a reaction product and subsequently
d) drying the reaction product to obtain the trans-polyoctenamer-graphene composite material, or by performing steps e and f:
e) subjecting trans-polyoctenamer to a ring opening metathesis polymerization and subsequently or simultaneously
f) adding graphene material and at least one solvent and at least one catalyst based on tungsten, ruthenium and/or molybdenum to obtain a reaction solution containing the trans-polyoctenamer-graphene composite material.

The process according to the invention has the advantage that it is very simple to perform and to thus attain a highly-filled composite material. In addition, compared to classical plastics and rubber compounding, no high shear forces are required to produce the composite material. However, exceptionally high filler contents with good dispersion quality are attained.

The invention therefore likewise provides the trans-polyoctenamer-graphene composite material characterized by
A) a filler content of graphene material of 15% to 99.9% by weight, wherein the filer content is based on the sum of the mass fractions of trans-polyoctenamer and graphene material and the sum amounts to 100% by weight, and
B) a dust number of 0.002% to 1% by weight when the filler content is from 15% to 70% by weight, and/or
C) suppressed and/or additional absorption bands in the IR absorption spectrum in the range from 500-1900 cm⁻¹ based on the IR absorption spectrum in each case of the trans-polyoctenamer and the graphene material and/or
D) a splitting of the absorption peak for the vibrational modes belonging to the C═C double bond into a discrete fine structure in the wavenumber range from 1300 to 3900 cm⁻¹.

A peak fine structure splitting in the IR spectrum is observed. Without being bound to a theory it is thought by the inventors that at least some of the peaks belong to the C═C double bond vibration which presumably couple differently in the composite material than in the pure graphene material/in the TOR. This results in the appearance of a discrete fine structure in the IR absorption spectrum of the composite material.

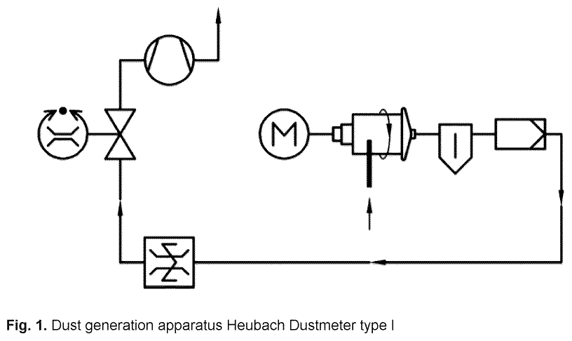

In the context of the invention the dust number is determined using a dust generation apparatus Heubach Dustmeter type I in the rotation method according to DIN 55992 (June 2006 edition), shown schematically in FIG. 1. The constructional details of this apparatus are known to the person skilled in the art.

The result of determining the dust number is the mass of dust liberated from the sample weight by the dustmeter at standard settings. In the context of the invention the standard settings according to DIN 55992-1 are selected:
30 revolutions/min
Air flow rate 20 L/min
100 L
5 min

The sample weight may be for example the graphene material employed in step b or f or the sample weight may be the trans-polyoctenamer-graphene composite material according to the invention or produced according to the invention.

The mass of dust liberated from the sample weight by the dustmeter at standard settings is based on the sample weight and reported in % by weight.

In the context of the invention the filler content is determined gravimetrically by dissolving the trans-polyoctenamer-graphene composite material according to the invention or produced according to the invention in toluene with stirring over 5 hours using a magnetic stirrer. The thus obtained solution is filtered through a Büchner funnel with a paper filer. The material retained on the paper filter comprises graphene material and residues of solvent. This material is dried and weighed on the paper filter in an oven at 50° C. In ambient air and standard pressure of 1013 hPa. The thus obtained and weighed mass is based on the sum of the mass fractions of trans-polyoctenamer and graphene material and is the filler content reported in % by weight.

The trans-polyoctenamer-graphene composite material according to the invention or produced according to the invention having the abovementioned high filler contents is suitable for much more interesting technical applications than mere blend material.

The Invention accordingly likewise provides for the use of the trans-polyoctenamer-graphene composite material according to the invention or obtained according to the invention in the automotive sector, in heat exchangers, in housings, encapsulations, plain bearings, in 3-D printing heads for heat removal, injection moulded parts, electronics applications, hose systems, membranes, fuel cells, cable systems, indoor and sports apparel, EM protection, orthopaedics.

The Invention is elucidated in more detail hereinbelow.

In the context of the invention trans-polyoctenamer is abbreviated to “TOR”. A trade name for TOR is Vestenamer®, obtainable from Evonik Operations GmbH, Essen.

In step a of the process according to the invention the organic solvent may be selected from hexane, chlorobenzene, toluene, tetrachloromethane, dichloromethane or a mixture of these solvents. Alternatively or in addition the solution may be produced by stirring over a duration of preferably 0.1 to 1 hours.

It may be advantageous to introduce the organic solvent while simultaneously introducing power. It is further preferable to effect thermostatting during production of the polymer solution of the trans-polyoctenamer in step a by removing undesired heat. Suitable solvents generally include all nonpolar organic solvents. Such solvents are known to those skilled in the art.

The introduction of energy in step b breaks up the aggregates of the graphene material. The resulting chunks are coated with the trans-polyoctenamer. This affords the trans-polyoctenamer-graphene reaction solution.

It may be advantageous in step b of the process according to the invention to introduce the graphene material into the polymer dispersion using means of assistance selected from ultrasound, ball mill, Dispermat, kneader, extruder, three roll mill. Ultra Turrax, wet jet mill. Conchier apparatus, high-shear mixer, preferably high-speed mixer, high speed mixer, Thermomixer or a combination of these means of assistance and/or by introducing power in the form of heat energy, microwave radiation and/or infrared radiation, wherein this energy is introduced with a mass-specific power of 10 to 400 W/kg, wherein the mass is the sum of the polymer dispersion and the graphene material and wherein the power is introduced over 0.1 to 99 hours, preferably over 0.1-6 hours, particularly preferably over 3 to 6 hours.

When two or more energy forms are employed, power is in the context of the invention to be understood as meaning the sum of the powers of energies introduced.

In step b it may likewise be advantageous to remove undesired heat energy formed depending on the starting state of the introduced graphene material. The graphene material may be in the form of a powder or pellet for example. Appropriate measures for thermostatting are known to those skilled in the art.

It is preferable when in the process the weight fraction of graphene material is 99-1% by weight and the weight fraction of trans-polyoctenamer is 1-99% by weight, wherein the weight fractions sum to 100% by weight.

In step c of the process according to the invention the reaction solution may be precipitated in a polar solvent, preferably using alcohol or water, particularly preferably using methanol or ethanol, very particularly preferably using ethanol, and/or the organic solvent(s) employed in step a may be removed using subatmospheric pressure, preferably under vacuum.

It is likewise preferable to allow the organic solvent employed in step a to evaporate under ambient conditions (20° C., 1013 hPa). It may furthermore be advantageous to remove the organic solvent employed in step a by freeze-drying. It is alternatively also possible to employ liquid nitrogen or dry ice, preferably dry ice. A cryo-milling process may be employed here.

In step d of the process according to the invention the reaction product may be dried under vacuum or by spray drying or in ambient air or a heating oven. This removes any remaining solvents. Drying agents are preferably silicic acids or silica.

The ring opening metathesis polymerization in step e of the process is known to those skilled in the art. It is elucidated in detail in the dissertation of Melanie Anselm, University of Freiburg: “Polyethylen-und Polyoctenamer-Nanokomposite durch katalytische Polymerisation in Gegenwart von funktionalisierfen Graphenen”, 2012, German National Library, Order no. 1123472896. In the context of the invention this ring opening metathesis polymerization is abbreviated to “ROMP”.

In step f of the process according to the invention the solvent may be selected from benzene, hexane, heptane, octane, toluene, cyclohexane, methylcyclohexane, isopropylcyclohexane, paraffin oil, methyl chloride, trichloroethylene, perchloroethylene, petroleum, cyclic olefin monomers, decalin, kerosene, desulfurized kerosene or a mixture of these solvents. Cyclooctene and/or cyclooctadiene may be employed with particular preference. Alternatively or in addition the catalyst may be selected from tungsten catalyst, preferably Schrock catalyst, or ruthenium-based catalyst, preferably Grubbs-Hoveyda.

If steps e and f are performed in the process according to the invention it is possible to employ alter or during performance of the ring opening metathesis polymerization 1% to 99% by weight of graphene material, particularly preferably 50% to 90% by weight, very particularly preferably 70% to 90% by weight of graphene material, wherein the weight fractions are based on the product or product mixture obtained after the ROMP and on the graphene material, which sum to 100% by weight.

Step f may particularly preferably employ those solvents where the solubility of the trans-polyoctenamer is utilized. Such solvents are known to those skilled in the art. Step f may be performed batchwise.

The trans-polyoctenamer-graphene composite material according to the invention is characterized by
A) a filler content or graphene material of 15% to 99.9% by weight, wherein the filler content is based on the sum of the mass fractions of trans-polyoctenamer and graphene material and the sum amounts to 100% by weight, and
B) a dust number of 0.002% to 1% by weight when the filler content is from 15% to 70% by weight,
   and/or
C) suppressed and/or additional absorption bands in the IR absorption spectrum in the range from 500-1900 cm⁻¹ based on the IR absorption spectrum in each case of the trans-polyoctenamer and the graphene material and/or
D) a splitting of the absorption peak for the vibrational modes belonging to the C═C double bond into a discrete fine structure in the wavenumber range from 1300 to 3900 cm⁻¹.

It Is preferable when the fine structure of the trans-polyoctenamer-graphene composite material according to the invention in feature D occurs at wavenumbers of 1300 to 2100 cm⁻¹ and of 3850 to 3900 cm⁻¹, particularity preferably in the range from 1300 to 2100 cm⁻¹.

It is preferable when the trans-polyoctenamer-graphene composite material according to the invention or produced according to the invention may have a filler content of 15% to 99.9% by weight, more preferably of 15% to 70% by weight, more preferably of 30% to 99.9% by weight, more preferably of 50% to 99.9% by weight, more preferably of 75.1% to 99.9% by weight, particularly preferably of 15% to 70% by weight.

It may be advantageous when the trans-polyoctenamer-graphene composite material according to the invention or produced according to the invention has a dust number in the range from 0.004% to 0.01% by weight at a filer content of 15% to 70% by weight.

The IR absorption spectrum of the trans-polyoctenamer-graphene composite material according to the invention or obtained according to the invention is based on the graphene material employed in step b or f and based on the trans-polyoctenamer employed in step a or e.

It is preferable when the IR absorption spectrum of the composite material according to the invention or obtained according to the invention has an additional absorption band in the range from 1500 to 1650 cm⁻¹ and/or in the range from 1700 to 1800 cm⁻¹.

It Is further preferable when the IR absorption spectrum of the composite material according to the invention or obtained according to the invention has a suppressed absorption band in the range from 1000 to 1400 cm⁻¹.

It is particularly preferable when this composite material has a suppressed absorption band in the range from 1000 to 1400 cm⁻¹ and an additional absorption band in the range from 1500 to 1650 cm⁻¹ and in the range from 1700 to 1800 cm⁻¹.

The invention likewise provides for the use of the trans-polyoctenamer-graphene composite material according to the invention or obtained according to the invention in the automotive sector, in heat exchangers, in housings, encapsulations, plain bearings, in 3-D printing heads for heat removal, in injection moulded parts, electronics applications, hose systems, membranes, fuel cells, cable systems, indoor and sports apparel, in EM protection, in orthopaedics.

Preferred possible applications are in thermoplastics selected from standard thermoplastics, preferably PE. PP, PS, PVC, alpha-olefins, butadiene derivatives, in engineering thermoplastics, preferably PET, PMMA, PC, POM, PA, PC, PBT, PEBA, TPU, PU, TPE, in high-performance thermoplastics, preferably PPS, PEEK, PES, PI, PEI, in copolymers, elastomers, preferably silicones, more preferably RTV, HTV, LSR, HCR, acrylates, pastes containing poly- and oligosiloxanes, in polyurethanes, rubbers, preferably SBR, BR, natural rubber, polybutadiene, functionalized polybutadienes, thermoplastic polyurethane, in thermosets, preferably polyurethanes, polyester resins, phenol resins, epoxy resins, acrylate resins, silicone resins, in solvents, preferably aprotic-nonpolar solvents, aprotic-polar solvents, protic solvents, in oils, preferably mineral oils, silicone oils, processing oils.

The Invention Is elucidated by way of example hereinbelow.

### Example 1. Trans-Polyoctenamer-Graphene Composite Material Composed of TOR and Graphene Nanoplatelets

Various trans-polyoctenamer-graphene composite materials were produced by initially dissolving trans-polyoctenamer in toluene. The example was also performable with hexane alternatively and with the same results.

Various proportions of graphene nanoplatelets were subsequently introduced, in each case affording a trans-polyoctenamer-graphene reaction solution.

The mixture was then stirred while introducing power by means of an ultrasound sonotrode, wherein this energy was introduced in constant fashion at a mass-specific power of 10 to 400 W/kg.

These reaction solutions were then each precipitated in ethanol and the respectively obtained reaction product dried, in each case affording trans-polyoctenamer-graphene composite material. The example was also performable with the methanol alternatively and with the same results.

The filler content of the composite material in each case obtained according to the invention, referred to in table 1 as “TOR-GBM Masterbatch”, was then determined at the different weight fractions of TOR and graphene material by dissolving in each case the trans-polyoctenamer-graphene composite material in toluene with stirring over 5 hours using a magnetic stirrer. The solution obtained in each case was filtered through a Büchner funnel with a paper filter. The material retained on the paper filter comprised graphene material and residues of solvent. This material was dried and weighed on the paper filter in an oven at 50° C. in ambient air and standard pressure of 1013 hPa. The filler content was calculated from the percentage weight fraction of the thus-obtained and weighed mass based on the sum of the mass fractions of trans-polyoctenamer and graphene material.

The results are shown in table 1.

TABLE 1
trans-polyoctenamer-graphene composite material “TOR-GBM
masterbatch” with different filler contents.

| | TOR:Graphene | TOR-GBM | Weight of | Filler content |
|---|---|---|---|---|
| Test | material (% by wt.) | Masterbatch (g) | GBM (g) | (% by wt.) |
| 39 | 90:10 | 1.0015 | 0.1487 | 15 |
| 46 | 70:30 | 1.0302 | 0.3398 | 33 |
| 34 | 50:50 | 0.9986 | 0.5461 | 55 |
| 47 | 30:70 | 1.0325 | 0.7736 | 75 |
| 48 | 10:90 | 1.0064 | 0.9408 | 94 |
| 49 | 5:95 | 0.9923 | 0.9936 | 99.9 |

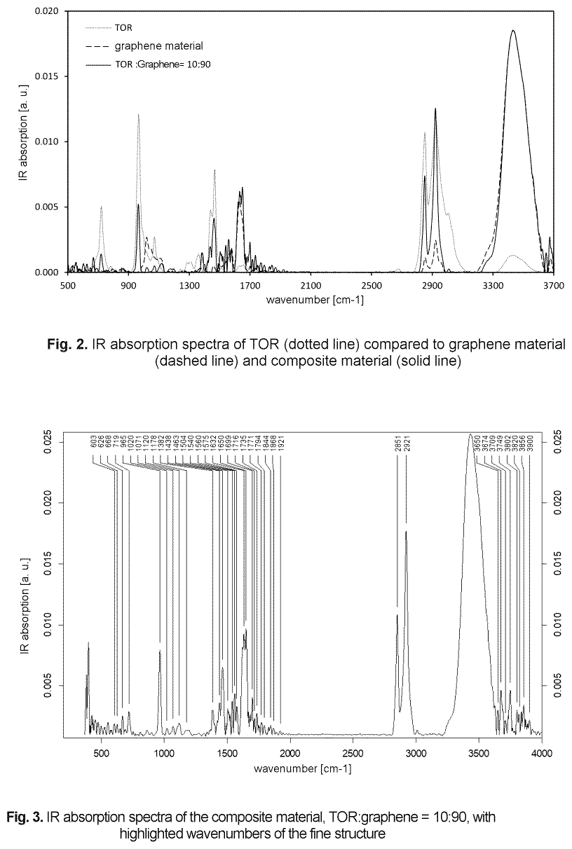

FIG. 2 shows the IR absorption spectra as a function of the wavenumber, namely of TOR as a dotted line, of the graphene material as a dashed line and of the inventive composite material in the case of the TOR:graphene ratio of 10:90 as a solid line.

FIG. 3 shows the same IR absorption spectrum as FIG. 2 but exclusively of the inventive composite material in the case of the TOR:graphene ratio of 10:90, wherein the wavenumbers of the discrete fine structure in the ranges from 1382 to 1921 cm⁻¹ and 3850 to 3900 cm⁻¹ are highlighted.

1: A process for producing a trans-polyoctenamer-graphene composite material, the process comprising:
performing a)-d):
a) dissolving a trans-polyoctenamer in at least one organic solvent, to obtain a polymer solution of the trans-polyoctenamer, and subsequently
b) introducing graphene material into the polymer solution while introducing power to obtain a trans-polyoctenamer-graphene reaction solution, and subsequently
c) precipitating the reaction solution in at least one further solvent, or
removing the at least one organic solvent employed in a) by drying the reaction solution,
to obtain a reaction product, and subsequently
d) drying the reaction product, to obtain the trans-polyoctenamer-graphene composite material,
or
performing e) and f):
e) subjecting a trans-polyoctenamer to a ring opening metathesis polymerization, and subsequently or simultaneously
f) adding graphene material and at least one solvent and at least one catalyst based on tungsten, ruthenium, and/or molybdenum, to obtain a reaction solution containing the trans-polyoctenamer-graphene composite material.

2: The process according to claim 1, wherein in a) the at least one organic solvent is selected from the group consisting of hexane, chlorobenzene, toluene, tetrachloromethane, dichloromethane, and a mixture thereof, and/or
wherein the polymer solution is produced by stirring.

3: The process according to claim 1, wherein in b) the graphene material is introduced into the polymer solution
by ultrasound, ball mill, Dispermat, kneader, extruder, three roll mill, Ultra Turrax, wet jet mill, Conchier apparatus, high-shear mixer, high speed mixer, Thermomixer, or a combination thereof, and/or
by introducing the power in the form of heat energy, microwave radiation, and/or infrared radiation, wherein this energy is introduced with a mass-specific power of 10 to 400 W/kg, wherein the mass is a sum of the polymer solution and the graphene material, and
wherein the power is introduced over 0.1 to 99 hours.

4: The process according to claim 3, wherein a weight fraction of the graphene material is 99-1% by weight and a weight fraction of the trans-polyoctenamer is 1-99% by weight, wherein the weight fractions sum to 100% by weight.

5: The process according to claim 1, wherein in c) the reaction solution is precipitated in a polar solvent, and/or
wherein the at least one organic solvent employed in a) are/is removed using subatmospheric pressure.

6: The process according to claim 1, wherein in d) the reaction product is dried under vacuum or by spray drying or in ambient air or a heating oven.

7: The process according to claim 1, wherein in f) the at least one solvent is selected from the group consisting of benzene, hexane, heptane, octane, toluene, cyclohexane, methylcyclohexane, isopropylcyclohexane, paraffin oil, methyl chloride, trichloroethylene, perchloroethylene, petroleum, cyclic olefin monomers, decalin, kerosene, desulfurized kerosene, and a mixture thereof, and/or
wherein the at least one catalyst is selected from the group consisting of a tungsten catalyst and a ruthenium-based catalyst.

8: The process according to claim 7, wherein after performance or during the ring opening metathesis polymerization (ROMP), 1% to 99% by weight of the graphene material is employed and the weight fractions are based on a product or product mixture obtained after the ROMP and on the graphene material, which sum to 100% by weight.

9: Trans-polyoctenamer-graphene composite material, comprising
A) a filler content of graphene material of 15% to 99.9% by weight, wherein the filler content is based on a sum of mass fractions of trans-polyoctenamer and graphene material and the sum amounts to 100% by weight, and
B) a dust number of 0.002% to 1% by weight when the filler content is from 15% to 70% by weight,
and/or
C) suppressed and/or additional absorption bands in an IR absorption spectrum in the range from 500-1900 cm⁻¹ based on the IR absorption spectrum in each case of the trans-polyoctenamer and the graphene material, and/or
D) a splitting of an absorption peak for vibrational modes belonging to the C═C double bond into a discrete fine structure in a wavenumber range from 1300 to 3900 cm⁻¹.

10: The trans-polyoctenamer-graphene composite material according to claim 9, comprising a filler content of 15% to 99.9% by weight.

11: An article, comprising:
the trans-polyoctenamer-graphene composite material according to claim 9,
wherein the article is an article in the automotive sector, in heat exchangers, in housings, in encapsulations, in plain bearings, in 3-D printing heads for heat removal, in injection moulded parts, in electronics applications, in hose systems, in membranes, in fuel cells, in cable systems, in indoor and sports apparel, in EM protection, or in orthopaedics.

12: A method, comprising:
adding the trans-polyoctenamer-graphene composite material according to claim 9 to a material selected from the group consisting of
a standard thermoplastic,
an engineering thermoplastic,
a high-performance thermoplastic,
a copolymer, an elastomer,
a polyurethane, a rubber,
a thermoset,
a solvent, and
an oil.

13: The process according to claim 2, wherein the polymer solution is produced by stirring over a duration of 0.1 to 1 hours.

14: The process according to claim 3, wherein the power is introduced over 3 to 6 hours.

15: The process according to claim 5, wherein the polar solvent is water, methanol, or ethanol.

16: The process according to claim 5, wherein the at least one organic solvent employed in a) is removed under vacuum.

17: The process according to claim 7, wherein the at least one solvent is cyclooctene or cyclooctadiene.

18: The process according to claim 7, wherein the tungsten catalyst is a Shrock catalyst, and the ruthenium-based catalyst is Grubb-Hoveyda catalyst.

19: The process according to claim 8, wherein after performance or during the ROMP, 70% to 90% by weight of graphene material is employed.

20: The trans-polyoctenamer-graphene composite material according to claim 10, wherein the filler content is 15% to 70% by weight.
